(19) United States
(12) Patent Application Publication
(10) Pub. No.: US 2011/0063662 A1
(43) Pub. Date: Mar. 17, 2011

(54) PRINTER AND PRINT DATA GENERATION METHOD

(75) Inventor: Hiroyuki Kato, Shizuoka (JP)

(73) Assignee: TOSHIBA TEC KABUSHIKI KAISHA, Tokyo (JP)

(21) Appl. No.: 12/868,983

(22) Filed: Aug. 26, 2010

(30) Foreign Application Priority Data
Sep. 15, 2009 (JP) 2009-213549

(51) Int. Cl. G06F 3/12

(52) U.S. Cl. 358/1.15

(57) ABSTRACT

According to one embodiment, a printer includes a storage unit which stores a format file having a plurality of fields respectively including data of a certain number of digits. The printer further includes a setting unit which associates a certain range of digits in a first field of the format file stored in the storage unit with one item of a plurality of items to be printed, and associates a certain range of digits in a second field different from the first field with the item. Further, the printer includes a generation unit which generates print data by extracting data in a certain range of digits in the first and second fields for the one item of the plurality of items to be printed in response to setting operations of the setting unit. The printer includes a printing unit prints the print data on a recording medium.

### CROSS-REFERENCE TO RELATED APPLICATIONS

This application is based upon and claims the benefit of priority from Japanese Patent Application No. 2009-213549, filed on Sep. 15, 2009, the entire contents of which is incorporated herein by reference.

### FIELD

Embodiments described herein relate generally to a printer and a print data generation method capable of designating a specific range of digits in a plurality of fields from a data format including a plurality of fields.

### BACKGROUND

In general, label printers are used for pricing products in supermarkets and the like. For example, a label printed by the label printer displays management data such as a product name, a product code, a bar code, and the like and product information such as a price. In the label printer, technologies for generating, managing, and retrieving the above-described product information are required for managing the product information by storing the product information in a storage area or retaining the product information in an external storage device, and executing a printing process of the label printer.

### BRIEF DESCRIPTION OF THE DRAWINGS

FIG. 1 is a block diagram showing an example of a label printer according to an embodiment.

FIG. 2 is an illustrative diagram of an example of a label to be printed by the label printer.

FIG. 3 is an illustrative diagram of an example of a label to be printed by the label printer.

FIG. 4 is an illustrative diagram of an example of a label to which an item to be printed by the label printer has been added.

FIG. 5 is a flowchart illustrating an example of generating and printing print data in the label printer.

FIG. 6 is an illustrative diagram showing an example of a data format creation tool for creating a data format in the label printer.

FIG. 7 is a diagram showing an example of a data format created in the label printer.

FIG. 8 is a flowchart illustrating an example of a matching process to be performed on a basis of a field digit unit in the label printer.

FIG. 9 is a flowchart illustrating an example of a matching process to be performed on a basis of a field digit unit in the label printer.

FIG. 10 is an illustrative diagram showing an example of a matching process tool in the label printer.

FIG. 11 is an illustrative diagram showing an example of a matching process tool in the label printer.

FIG. 12 is an illustrative diagram showing an example of a matching process tool which executes a matching process on a basis of a field digit unit in the label printer.

FIG. 13 is an illustrative diagram showing an example of a matching process tool which executes a matching process on a basis of a field digit unit in the label printer.

FIG. 14 is a block diagram showing a process of a label printer according to another embodiment.

FIG. 15 is a flowchart illustrating an example of printing a label according to another embodiment.

### DETAILED DESCRIPTION

According to one embodiment, a printer includes a storage unit which stores a format file having a plurality of fields respectively including data of a certain number of digits, and a setting unit which associates a certain range of digits in a field of the format file stored in the storage unit with one item of a plurality of items to be printed on a recording medium. The printer further includes a generation unit which in response to a setting operation of the setting unit, generates print data for the one item of the plurality of items by extracting data from the storage unit for the certain range of digits in the field of the format file stored in the storage unit. The printer further includes a printing unit which performs a printing operation on the recording medium on the basis of the print data generated by the generation unit.

The first embodiment will now be described in detail with reference to the drawings.

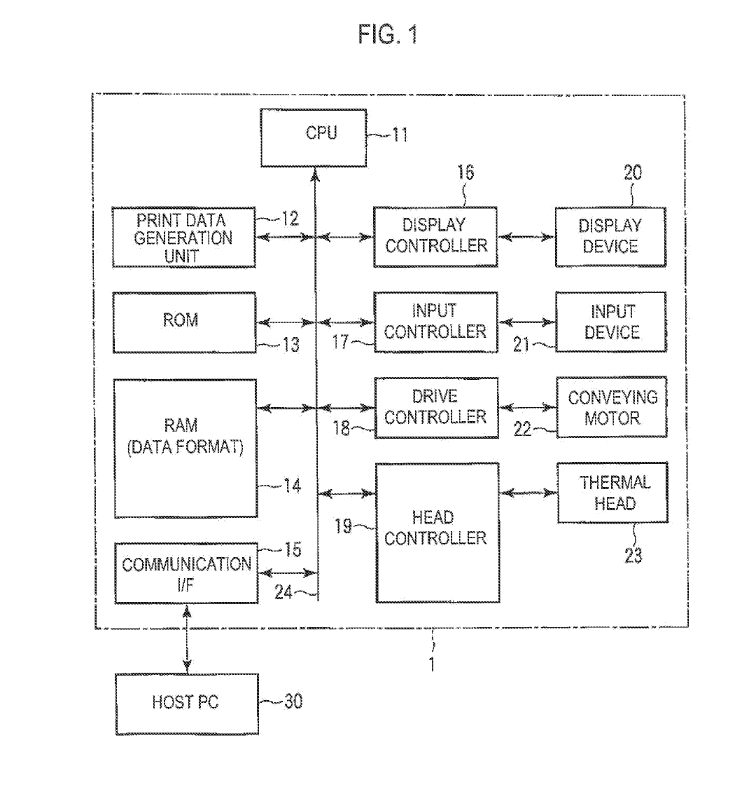

A label printer 1 according to one embodiment will be described with reference to FIG. 1. As shown in FIG. 1, the label printer 1 includes a CPU 11 serving as a setting unit which controls the overall operation, a bus line 24 which connects the CPU 11 to respective units (which will be described in detail below), a print data generation unit 12 serving as a generation unit which generates a data format or generates print data based on the data format, a ROM 13 which stores various operation programs, a RAM 14 serving as a storage unit which stores the generated data format, various types of control information, or the like, and a communication interface 15 which performs communication with an external device such as a host computer 30 via a network. The label printer 1 further includes a display device 20 which displays an image of a label to be printed, a data format creation tool, a matching process tool, or the like on a screen, a display controller 16 which controls the display device 20, an input device 21 such as a keyboard and a scanner, which inputs operation information or data included in the above-described data format, an input controller 17 which controls the input device 21. Further, the label printer 1 includes a conveying motor 22 which conveys a recording medium such as a sheet of paper on which a label is printed, a drive controller 18 which controls the operation of the conveying motor 22, a thermal head 23 serving as a printing unit which prints a label image on the recording medium, and a head controller 19 which drives the thermal head 23.

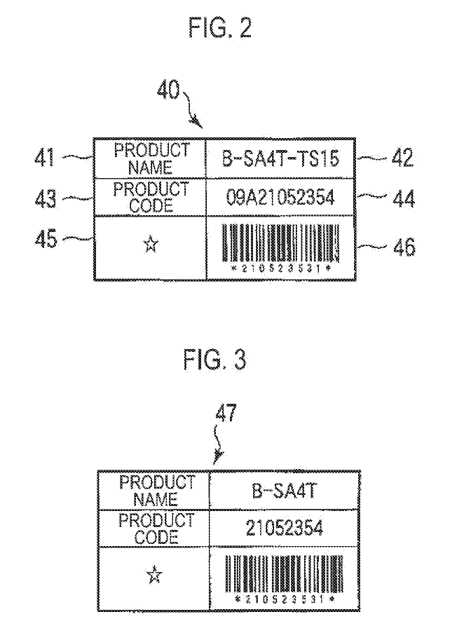

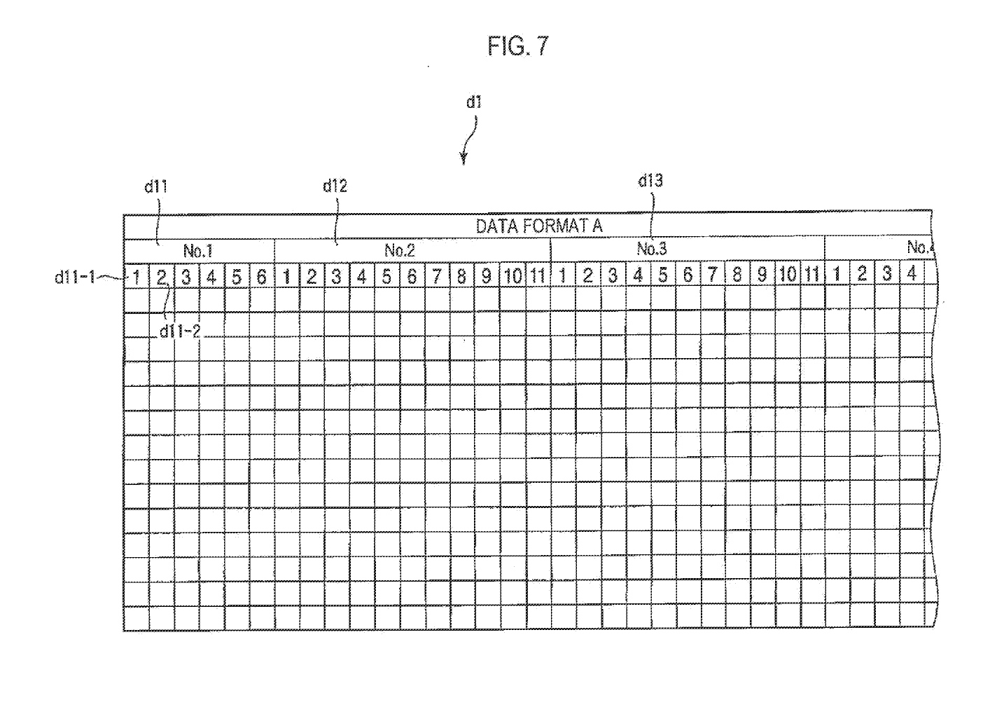

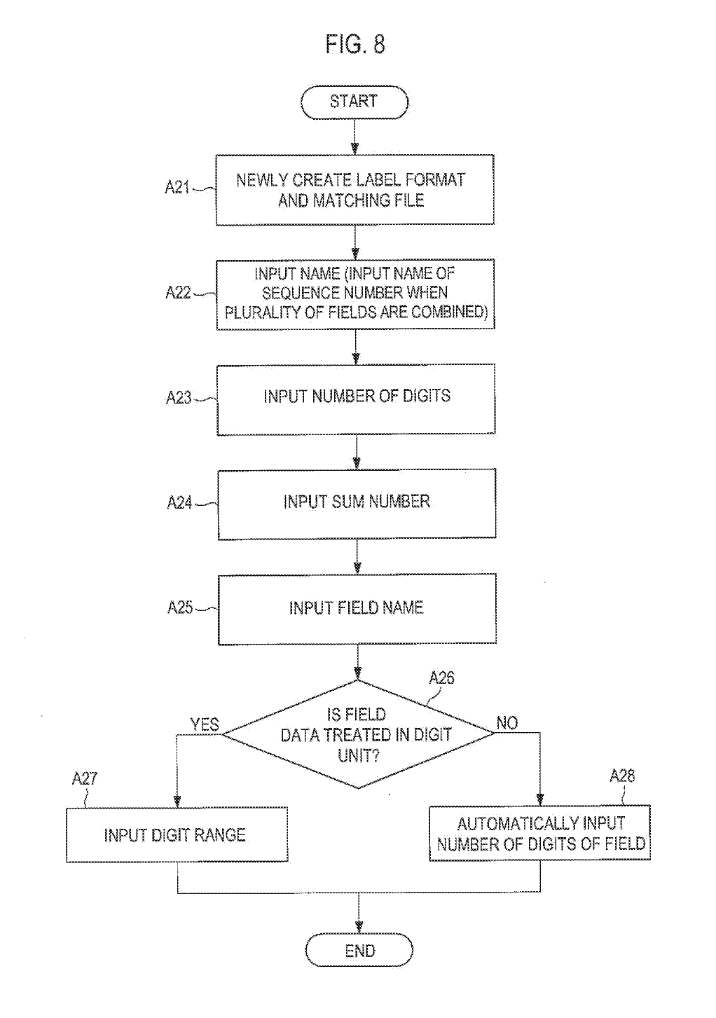

The label printer 1 of the present embodiment with the above-described configuration prints labels 40, 47, and 40′ as shown in FIGS. 2 to 4 on recording media such as sheets of papers using the thermal head 23. Such printing of labels is performed using print data generated on the basis of a data format as shown in FIG. 7 generated by the print data generation unit 12 under control of the CPU 11.

For example, this print data generation process may be implemented by a computer program which is stored in the ROM 13 or the RAM 14. Further, the computer program may be executable in the CPU 11 and the print data generation unit 12. Likewise, the print data generation process may be implemented by the operation of the CPU 11 and the circuit of the print data generation unit 12. It is also possible to implement the print data generation process with any other configurations.

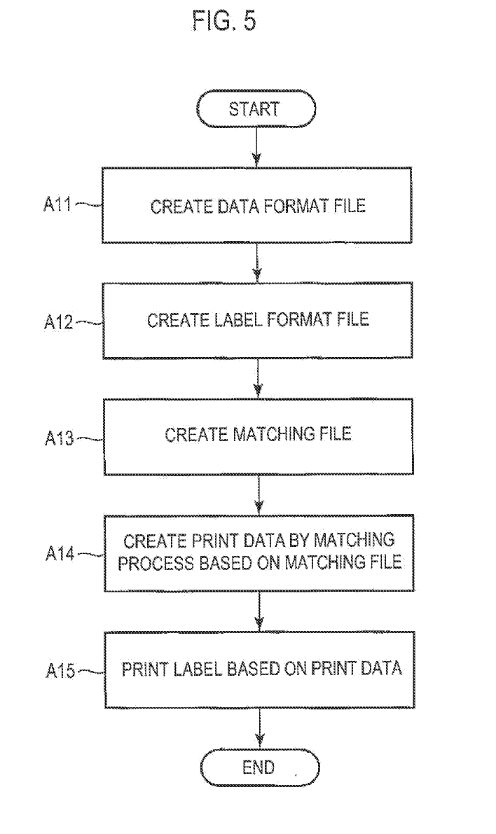

As shown in the flowchart of FIG. 5, in a process of generating print data and printing a label in the print data generation unit 12, the print data is generated as follows. A data format file (DFM file) is generated to include a data format created by a data format creation tool (act A11). A label format file (LFM file) is then generated to include a label format created by a format generator (FG) (act A12). A matching file (CMD file) is generated by matching a field of the LFM file and a field of the DFM file using a matching tool (act A13). Then, print data is generated on the basis of the created matching file (CMD file) (act A14). Thereafter, a label is printed on a recording medium on the basis of the generated print data (act A15).

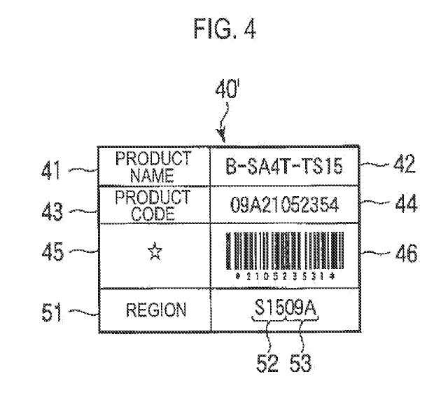

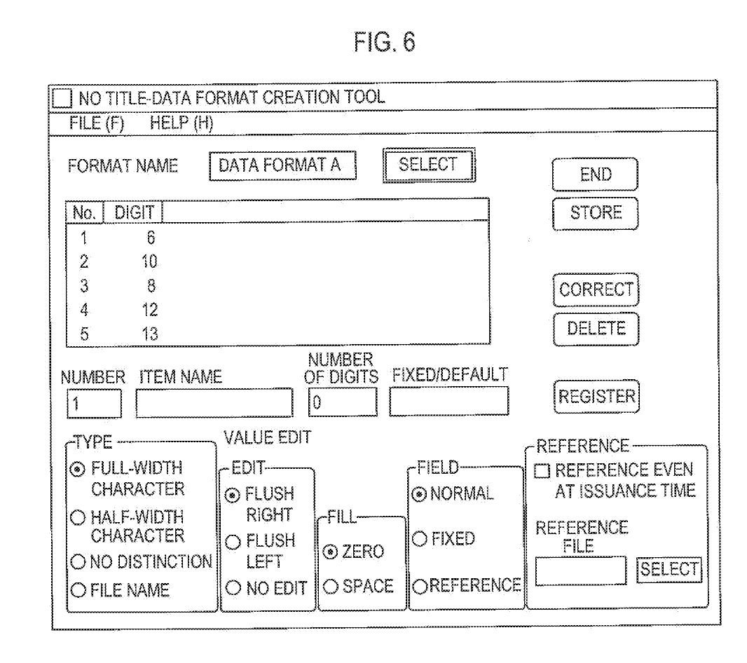

Hereinafter, a process of generating print data to print a label and printing the label will be described with reference to FIG. 2 or FIG. 4. along with “a matching process to be performed in field digit unit” according to one embodiment. First, the CPU 11 and the print data generation unit 12 display a data format creation tool (as shown in FIG. 6) on the display device 20 in response to a user's operation of the input device 21. A data format d1 as shown in FIG. 7 is generated according to “Format Name”, “No.”, “Number of Digits”, “Item Name”, and the like, which is input as shown on a screen of the data format creation tool.

The data format d1 has a plurality of fields d11, d12, d13, etc. For example, it can be seen that the first field d11 has a field name “Record Number” and includes 6-digit data. Likewise, the second field d12, the third field d13, etc. are subsequently arranged in the data format d1.

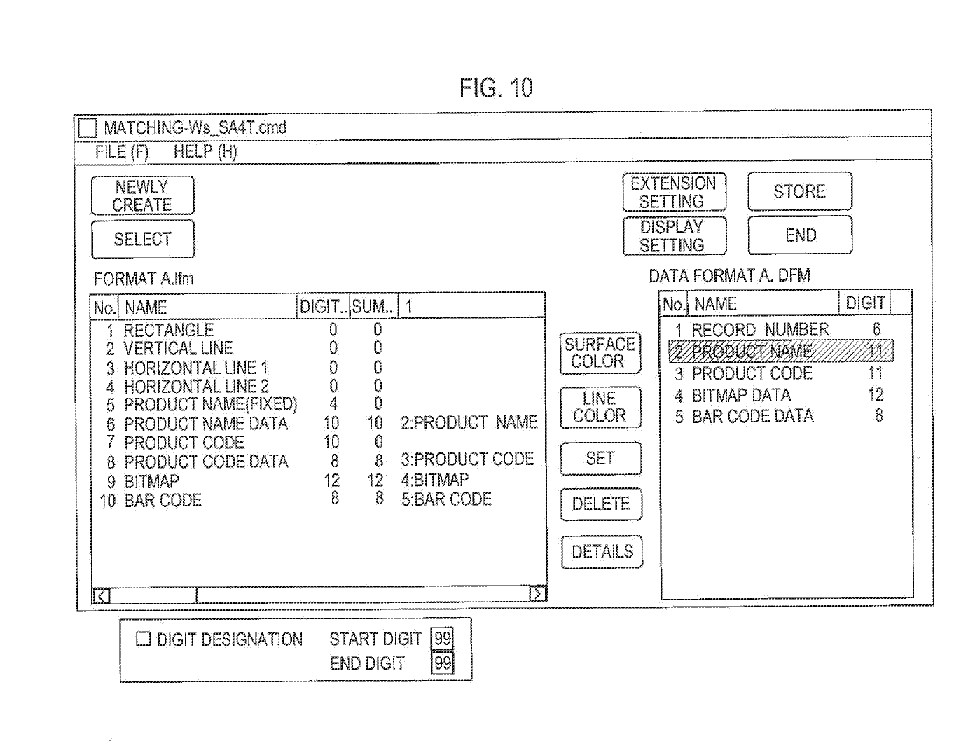

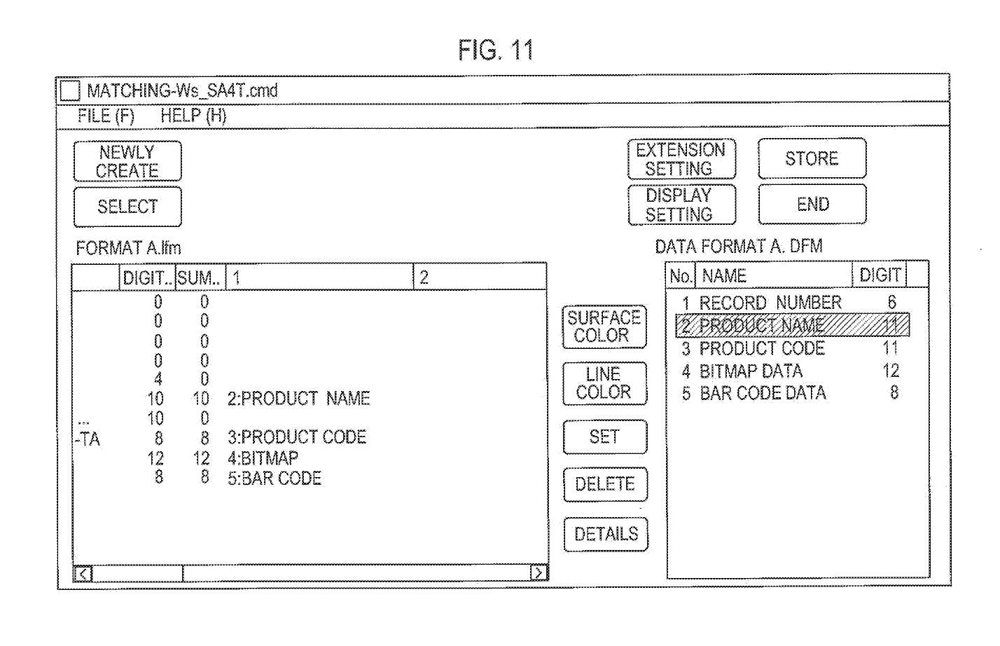

The CPU 11 and the print data generation unit 12 newly create a label format file (LFM file), e.g., a format A.lfm displayed on a matching tool as shown in FIG. 10 (act A21). That is, first, as shown in FIG. 10, names such as “Rectangle”, “Product Code”, or the like are associated with respective “No.” (act A22). The label format file is generated by a format generator (not shown), but may be generated based on data shown on the screen of the matching tool.

After, for example, when the name of the label format file is the label format file A.lfm as shown in FIG. 10, the CPU 11 and the print data generation unit 12 input “Rectangle” for “No. 1” and input “Product Code” for “No. 7” (act A22).

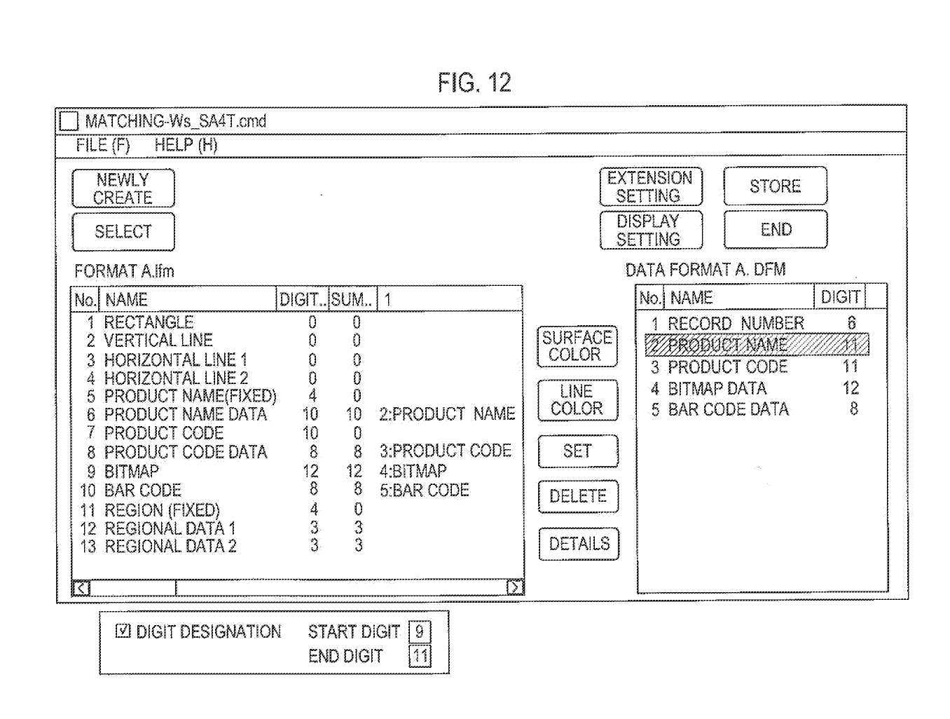

In case a plurality of fields are combined as shown in format A.lfm of the matching tool in FIG. 12, the CPU 11 and the print data generation unit 12 may use a method of creating different names by incrementing a number attached to the same name by 1 such as “Regional Data 1” for “No. 12” and “Regional Data 2” for “No. 13.” However, the method of creating names is not limited thereto.

After, for example, the CPU 11 and the print data generation unit 12 input the number of digits for a name, e.g., “10” in case of “No. 6” and “Product Name Data” (act A23), and input a sum number for the name, e.g., “10” (act A24).

Then, the CPU 11 and the print data generation unit 12 input a field name corresponding to the name in response to the user's input (act A25). The CPU 11 determines whether the user's input indicates that field data is to be treated as a digit unit or a field unit (act A26) In one embodiment, when determining that the user's input indicates that field data is to be treated as a digit unit, for example, the user may input a name by adding a sequence of numbers following the same name as in “Regional Data 1” for “No. 12” and “Regional Data 2” for “No. 13” as shown in FIG. 12. However, it should be noted that the embodiment of inputting a name is not limited thereto. The CPU 11 and the print data generation unit 12, for example, input the field name for “Regional Data 1” as “2. Product Name (9-11)” and input the field name for “Regional Data 2” as “3. Product Code (1-3)” (act A27) in response to the user's input. At this time, for example, the field name may be set by clicking a check box titled “digit designation” on a lower portion of the matching tool of FIG. 12 and respectively inserting “9” and “11” or “1” and “3” into the “start digit” and “the end digit” fields.

In the present embodiment, “2. Product Name (9-11)” indicates that print data is to be generated on the basis of data included in the 9^{th} to 11^{th} digits of “2. Product Name” field. On the other hand, “3. Product Code (1-3)” indicates that print data is to be generated on the basis of data included in the 1^{st} to 3^{rd} digits of “3. Product Code” field.

In act A26, in case of determining that the field data is not treated in the digit unit (i.e., in case of selecting “NO” in act A26), the CPU 11 and the print data generation unit 12 input a field name corresponding to the name in response to the user's input by automatically inputting the number of digits in the field digits. For example, “2. Product Name (10)” shown in FIG. 11 indicates that the number of digits “10” in the field “2 Product Name” is automatically generated and input (act A28). In the manner as described above, the input process of the matching file (CMD file) associated with the format A.lfm file is completed.

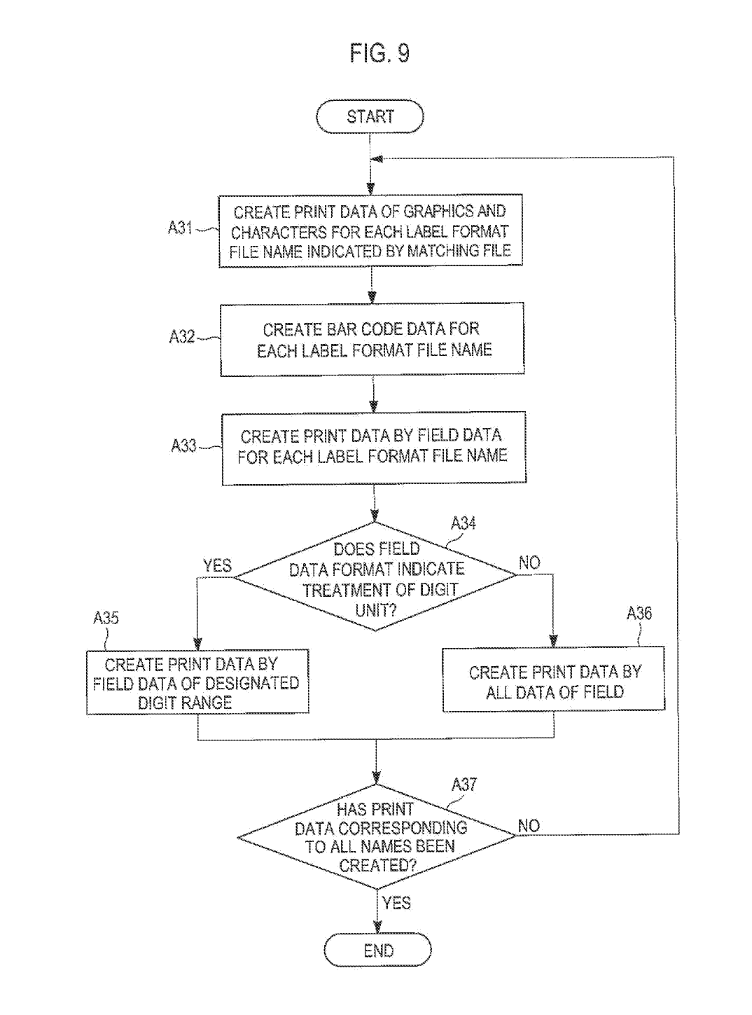

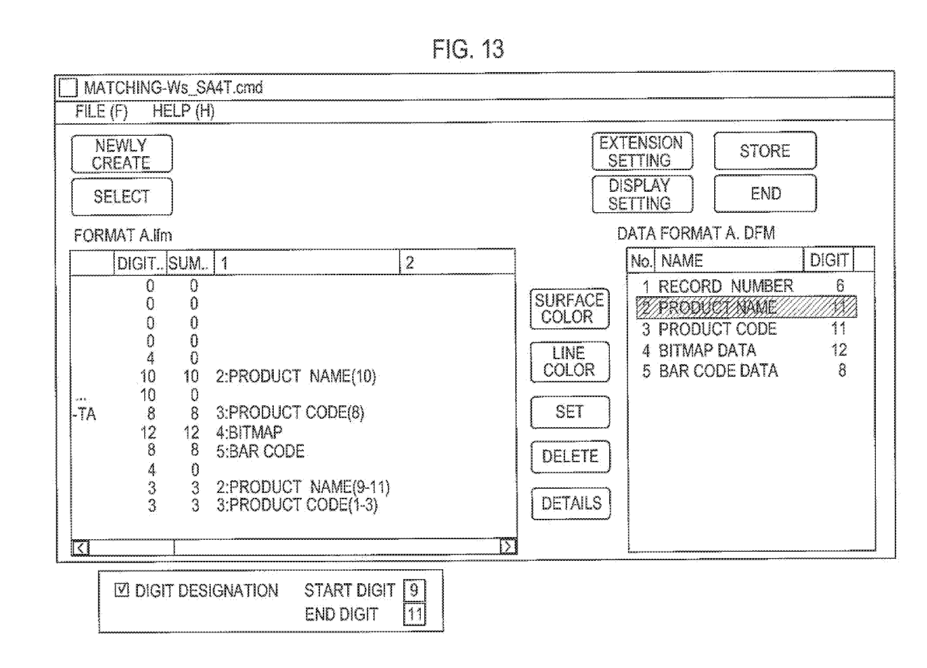

After, as shown in the flowchart of FIG. 9, print data is generated by executing the matching process based on the generated matching file (CMD file). That is, for example, in response to the user's operation, the CPU 11 and the print data generation unit 12 create print data of graphics or characters for respective names in the label format file shown in the matching file displayed on the matching tool, as shown in FIGS. 12 and 13 (act A31). Thereby, for example, print data of graphics such as a rectangle, a vertical line, and a horizontal line are created as shown in the labels 40, 47, and 40′ of FIGS. 2 to 4. Further, print data of characters, “Product Name” 41, “Product Code” 43, and “*” 45 are created as shown in the labels 40, 47, and 40′ of FIGS. 2 to 4.

Subsequently, the CPU 11 and the print data generation unit 12 create bar code data for printing a bar code such as a bar code 46 of FIG. 2 or a bar code 46 of FIG. 4 for respective label format file names (act A32). The CPU 11 and the print data generation unit 12 create print data based on field data for respective names in the label format file (act A33). Then, the CPU 11 and the print data generation unit 12 determine whether data format in the matching file uses entire data in the corresponding field such as “2. Product Name (10)” or uses a certain range of digits in the data field such as “2. Product Name (9-11)” (act A34).

In case it is determined that the data format in the matching file uses a certain range of digits in the data field such as “2. Product Name (9-11)” (i.e., in case of selecting “YES” in act A34), the CPU 11 and the print data generation unit 12 create print data by combining data (in digit unit) from different fields such as “S15” 52 and “09A” 53 which are indicated as print data of the label 40′ in FIG. 4 (act A35).

In particular, as shown in the print data 42 of FIG. 2, the print data “S15” 52 is generated from data in 9^{th} to 11^{th} digits of “2. Product Name” field. Also, as shown in the print data 44 of FIG. 2, the print data “09A” 53 is generated from data in 1^{st} to 3^{rd} digits of “3. Product Code” field.

On the other hand, in case of determining that the data format in the matching file uses entire data in the field (i.e., data in field unit) such as “2. Product Name (10)” (i.e., in case of selecting “NO” in act A34), data in the entire 10 digits of “2. Product Name (10)” field such as print data “B-SA4T-TS15” 42 of the label 40 of FIG. 2 (corresponding to “2. Product Name (10)” of the format A.lfm shown in the matching tool of FIG. 11) is created as print data (act A36).

If it is determined that the process for all names of the matching file has not been completed (i.e., in case of “NO” in act A37), the CPU 11 and the print data generation unit 12 return to act A31 and continue the process. On the other hand, if it is determined that the process for all names of the matching file has been completed (i.e., in case of “YES” in act A37), the print data generation process is completed.

According to the embodiments as described above, in the process of registering data in a data file, the label printer 1 can designate a range of digits in a field of the DFM file for a matching process, as compared to the conventional process where the data registration is performed only in a field unit. Accordingly, since a specific range of digits in a field can be designated, it is possible to easily prepare necessary print data by specifying desired data from an existing field in a digit unit. For example, it is not necessary to create an entire label format file for preparing print data for “S1509A” of “Region” 51 in the label 40′ of FIG. 4. Accordingly, it is possible to rapidly execute a necessary label printing process without involving a complicated process of creating a label format file through user's input by the input device 21 or the like.

The second embodiment will now be described with reference to the drawings. For the purpose of brevity, explanation on the configurations which is the same as those of the first embodiment is omitted.

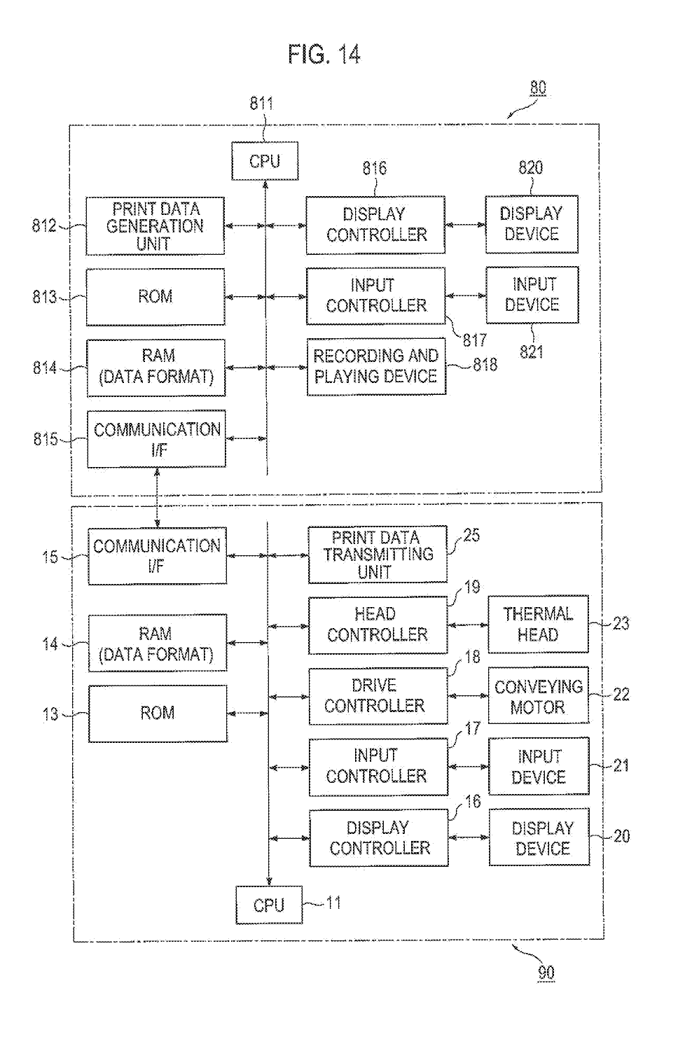

A host computer 80 according to one embodiment will be described in detail with reference to FIG. 14. The host computer 80 includes a CPU 811 serving as a setting unit which controls the overall operation, a bus line 824 which connects the CPU 11 to respective units (which will be described in detail below), a print data generation unit 812 serving as a generation unit which generates a data format or generates print data based on the data format, a ROM 813 which stores various operation programs, a RAM 814 serving as a storage unit which stores the generated data format, various types of control information, or the like, and a communication interface 15 which performs communication with an external device such as a printer or the like via a network. The host computer 80 further includes a display device 820 which displays an image of a label to be printed, a data format creation tool, a matching process tool, or the like on a screen, a display controller 816 which controls the display device 820, an input device 21 such as a keyboard, a scanner, or the like which inputs operation information or data included in the above-described data format, an input controller 817 which controls the input device 21, and a recording and playing device 818 which records and plays data such as print data, format data, or the like. The recording and playing device 818 may be a recording device which record data to a magnetic recording medium, an optical recording medium, or the like.

The label printer 90 includes a CPU 11 serving as a setting unit which controls the overall operation, a bus line 24 which connects the CPU 11 to respective units (which will be described in detail below), a ROM 13 which stores various operation programs, a RAM 14 serving as a storage unit which stores the generated data format, various types of control information, or the like, and a communication interface 15 which performs communication with an external device such as a host computer 80 via a network. The label printer 90 may further include a display device 20 which displays various information on a screen, a display controller 16 which controls the display device 20, an input device 21 such as a keyboard and a scanner, which inputs operation information or data included in the above-described data format, an input controller 17 which controls the input device 21, a conveying motor 22 which conveys a recording medium such as a sheet of paper on which a label is printed, a drive controller 18 which controls the operation of the conveying motor 22, a thermal head 23 serving as a printing unit which prints a label image on the recording medium, and a head controller 19 which drives the thermal head 23. The label printer 90 further includes a print data transmitting unit 25 which transmits to the RAM 14 the print data transmitted from the host computer 80 via the communication interface 15.

The host computer 80 exchanges various data such as the print data or the like with the label printer 90 via the communication interface 15.

The host computer 80 prints labels 40, 47, and 40′ as shown in FIGS. 2 to 4 on recording media such as sheets of papers using the thermal head 23. Such printing of labels is performed using print data generated on the basis of a data format as shown in FIG. 7 generated by the print data generation unit 812 under control of the CPU 811.

The host computer 80 configured as described above newly creates label format file (LFM file) by displaying a data format creation tool, a matching process tool, or the like on a screen of the display device 820 under control of the CPU 811.

This print data generation process may be implemented by a computer program which may be executable in the CPU 811 and the print data generation unit 812. This computer program is stored in the ROM 813 or the RAM 814 of the host computer 80. Likewise, the print data generation process may be implemented by the operation of the CPU 811 and the circuit of the print data generation unit 812. It is also possible to implement the print data generation process with any other configurations.

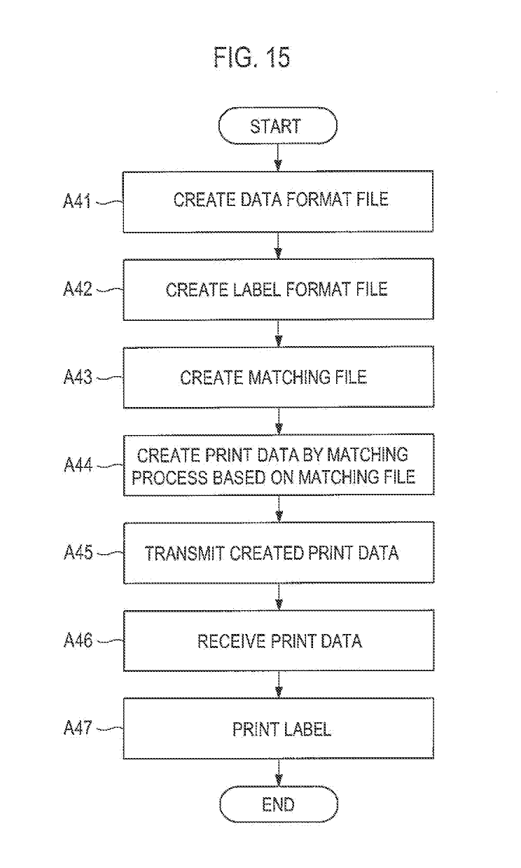

The process of generating print data and printing a label in the print data generation unit 812 is performed as shown in the flowchart of FIG. 15. The print data generation unit 812 generates the print data as follows. A data format file (DFM file) is generated to include a data format created by a data format creation tool (act A41). A label format file (LFM file) is then generated to include a label format created by a format generator (FG) (act A42). A matching file (CMD file) is generated by matching a field of the LFM file and a field of the DFM file using a matching tool (act A43). Then, print data is generated on the basis of the created matching file (CMD file) (act A44). Thereafter, the host compute 80 transmits the generated print data to the label printer 90 (act A45).

The label printer 90 receives the print data transmitted from the host computer 80 (act A46). Then, the label printer 90 performs the printing of a label on a recording medium based on the created print data (act A47).

That is, the label printing process according to the second embodiment is different from that of the first embodiment in that the host computer creates the print data and transmits the created print data to the label printer 90 (act A45) and that the label printer performs printing based on the received print data (acts A46 and A47).

In this regard, creating a print data performed by the host computer 80 and the print data generating unit 812 as illustrated in FIGS. 2 to 4, are performed in the same manner as the first embodiment. That is, the CPU 811 displays a data format creation tool (as shown in FIG. 6) on the display device 820 and creates the data format shown in FIG. 7 in response to a user's operation of the input device 821.

The CPU 811 and the print data generation unit 812 create a label format file (LFM file), e.g., a format A.lfm displayed on a matching tool as shown in FIG. 10, and performs the matching process using the matching tool as shown in FIGS. 12 and 13 thereby generating the print data.

The print data generated in the host computer 80 is transmitted to the label printer 90, an then the label printer receives the print data and performs the printing of a label based on the print data.

In this regard, the creation of the print data does not have to be performed by the host computer 80, and it may be possible to perform generating the print data using a portable device such as a PDA according the second embodiment thereby creating the print data.

According to the second embodiment, in the same manner as the first embodiment, the host computer 80 may easily generate the required print data by specifying certain required digits of data from a pre-existing field. Thus, the label format file does not need to be newly created. Accordingly, it is possible to create a required label format quickly in response to a user's request without complicated procedures such as manually inputting data. Therefore, it is possible to perform printing of a label quickly.

For example, the print data generation process described above with reference to the drawings may be stored in the ROM 13 or the RAM 14, and is implemented by a computer program to be processed by the CPU 11 and the print data generation unit 12. Likewise, the print data generation process may be implemented by the operation of the CPU 11 and the action of the circuit of the print data generation unit 12 or any other configurations.

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in the apparatus, can be downloaded through a network to the apparatus and can be installed in the apparatus from a computer readable storage medium storing the program therein. A form of the computer readable storage medium can be any form as long as the computer readable storage medium can store programs and is readable by the apparatus such as a disk type ROM and a solid-state computer storage media. The functions obtained by installation or download in advance in this way can be realized in cooperation with an OS (Operating System) or the like in the apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer comprising:
a storage unit configured to store a format file having a plurality of fields respectively including data of a certain number of digits;
a setting unit configured to associate a certain range of digits in a first field of the format file stored in the storage unit with one item of a plurality of items to be printed on a recording medium and further associates a certain range of digits in a second field of the format file, which is different from the first field, with the one item;
a generation unit configured to generate print data for the one item of the plurality of items in response to a setting operation of the setting unit by extracting data from the certain range of digits in the first field of the format file stored in the storage unit and further extracting data from the certain range of digits in the second field of the format file; and
a printing unit configured to perform a printing operation on the recording medium on the basis of the print data generated by the generation unit.

2. The printer of claim 1,
wherein the setting unit further associates all digits in a certain field of the format file with one item of the plurality of items recorded on the recording medium, and
wherein the generation unit generates print data for the one item of the plurality of items by extracting data of all the digits of the certain field of the format file stored in the storage unit in response to setting operation of the setting unit.

3. The printer of claim 1 wherein the data extracted by the generation unit is bar code data.

4. A printer comprising:
a storage unit configured to store a format file having a plurality of fields respectively including data of a certain number of digits;
a setting unit configured to associate a certain range of digits in a field of the format file stored in the storage unit with one item of a plurality of items to be printed on a recording medium;
a generation unit configured to generate print data by extracting data from the certain range of digits in the field of the format file stored in the storage unit for the one item of the plurality of items in response to a setting operation of the setting unit; and
a printing unit configured to perform a printing operation on the recording medium on the basis of the print data generated by the generation unit.

5. The printer of claim 4,
wherein the setting unit further associates all digits in a certain field of the format file with one item of the plurality of items recorded on the recording medium, and
wherein the generation unit generates print data for the one item of the plurality of items by extracting data of all the digits of the certain field of the format file stored in the storage unit in response to setting operation of the setting unit.

6. The printer of claim 4 wherein the data extracted by the generation unit is bar code data.

7. A print data generation method comprising:
storing a format file having a plurality of fields respectively including data of a certain number of digits in a storage area;
setting a certain range of digits in a first field of the format file to be associated with one item of a plurality of items to be printed on a recording medium;
further setting a certain range of digits in a second field different from the first field to be associated with the item; and
generating print data for the one item of the plurality of items in response to the respective setting operations by extracting data from the certain range of digits in the first field of the stored format file and by further extracting data from the certain range of digits in the second field from the storage area.

8. The print data generation method of claim 7,
wherein all digits of a certain field of the format file are further set to be associated with one item of the plurality of items to be recorded on the recording medium, and
wherein print data is generated by extracting data of all the digits of the certain field of the stored format file for the one item of the plurality of items in response to the setting operations.

9. The print data generation method of claim 7 wherein the data extracted when generating print data is bar code data.

10. A print data generation method comprising:
storing a format file having a plurality of fields respectively including data of a certain number of digits in a storage area;
setting a certain range of digits in a field of the format file stored in the storage area to be associated with one item of a plurality of items to be printed on a recording medium; and
generating print data by extracting data from the certain range of digits in the field of the stored format file for the one item of the plurality of items in response to the setting operation.

11. The print data generation method of claim 10,
wherein all digits of a certain field of the format file are further set to be associated with one item of the plurality of items to be recorded on the recording medium, and
wherein print data is generated by extracting data of all the digits of the certain field of the stored format file for the one item of the plurality of items in response to the setting operations.

12. The print data generation method of claim 11 wherein the data extracted when generating print data is bar code data.

13. A computer-readable storage medium storing instructions that, when executed by a computer, cause the computer to perform the operations of:
storing a format file having a plurality of fields respectively including data of a certain number of digits in a storage area;
setting a certain range of digits in a first field of the format file to be associated with one item of a plurality of items to be printed on a recording medium;
further setting a certain range of digits in a second field different from the first field to be associated with the item; and
generating print data for the one item of the plurality of items in response to respective setting operations by extracting data from the certain range of digits in the first field of the stored format file and by further extracting data from the certain range of digits in the second field from the storage area.

14. The computer-readable storage medium of claim 13,
wherein all digits of a certain field of the format file are further set to be associated with one item of the plurality of items to be recorded on the recording medium, and
wherein print data is further generated by extracting data of all the digits of the certain field of the stored format file for one item of the plurality of items in response to the setting operations.

15. A computer-readable storage medium storing instructions that, when executed by a computer, cause the computer to perform the operations of:
storing a format file having a plurality of fields respectively including data of a certain number of digits in a storage area;
setting a certain range of digits in a field of the format file stored in the storage area to be associated with one item of a plurality of items to be printed on a recording medium; and
generating print data by extracting data from the certain range of digits in the field of the stored format file for the one item of the plurality of items in response to the setting operation.

16. The computer-readable storage medium of claim 15,
wherein all digits of a certain field of the format file are further set to be associated with one item of the plurality of items to be recorded on the recording medium, and
wherein print data is further generated by extracting data of all the digits of the certain field of the stored format file for one item of the plurality of items in response to the setting operations.

17. A print data generation device comprising:
a storage unit configured to store a format file having a plurality of fields respectively including data of a certain number of digits;
a setting unit configured to associate a certain range of digits in a first field of the format file stored in the storage unit with one item of a plurality of items to be printed on a recording medium and further associates a certain range of digits in a second field of the format file, which is different from the first field, with the one item; and
a generation unit configured to generate print data for the one item of the plurality of items in response to a setting operation of the setting unit by extracting data from the certain range of digits in the first field of the format file stored in the storage unit and further extracting data from the certain range of digits in the second field of the format file.

18. The print data generation device of claim 17 further comprising:
a transmitting unit configured to transmit to a printer the print data generated by the generation unit

19. The print data generation device of claim 17,
wherein the setting unit further associates all digits in a certain field of the format file with one item of the plurality of items recorded on the recording medium, and
wherein the generation unit generates print data for the one item of the plurality of items by extracting data of all the digits of the certain field of the format file stored in the storage unit in response to setting operation of the setting unit.

20. The print data generation device of claim 17 wherein the data extracted by the generation unit is bar code data.
